(19) United States
(12) Patent Application Publication
(10) Pub. No.: US 2012/0112596 A1
(43) Pub. Date: May 10, 2012

(54) DC COMMUTATOR DOUBLY SALIENT RELUCTANCE MOTOR

(76) Inventor: Lumin Feng, Beijing (CN)

(21) Appl. No.: 13/145,903

(22) PCT Filed: Jan. 22, 2010
(86) PCT No.: PCT/CN2010/070338

§ 371 Date: Sep. 30, 2011

(30) Foreign Application Priority Data
Jan. 24, 2009 (CN) 200910000999.9

(51) Int. Cl. H01R 39/04; H02K 23/44

(52) U.S. Cl. 310/209; 310/233

(57) ABSTRACT

A dc commutator doubly salient reluctance motor is composed of a stator component, a rotor component, a commutator component, a brush component and a motor housing. The commutator does not rotate with a shaft, but the brush rotates with the shaft. The number of commutator segments connected with stator windings is the lease common multiple of the number of stator salient poles and the number of rotor salient poles. The number of brushes is at most equal to the number of the rotor salient poles. The connecting sequence that the commutator segments are connected with the stator windings is contrary to the distributing sequence that the stator windings are arranged on the stator salient poles. The speed-adjusting, braking and reversal of the motor are achieved by shifting the circumferential position that the commutator surrounds the shaft. The output power and the mechanical-electrical efficiency of the motor are changed by the included angles between the brush's front and back edges. Therefore, the special vibration and noise of switched reluctance motor are greatly eliminated.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a DC doubly salient reluctance motor driven by a commutator and brushes.

2. Description of Related Art Including Information Disclosed Under 37 CFR 1.97 and 37 CFR 1.98

It is well known that ordinary brushed DC motors are commutated with commutators and brushes. Fixed brushes contacting with rotating commutators are employed by this kind of motor, importing electric energy into different rotor windings by way of switching during rotation, completing the magnetic polarity switch of the rotors, and actuating the rotors to rotate.

However, there are several drawbacks in the operation methods of the commutators and brushes.

(1) The motor speed could not be too high due to the limit of the commutator structural strength.

(2) There exist commutator sparks between the commutator and brushes, causing electromagnetic interference and short lifetime.

(3) The commutators need routine maintenance, and the maintenance workload is very heavy.

(4) The motor efficiency is low.

The windings of switched reluctance motors are located on stators, and its rotors are entirely cores. The core rotors are driven by this kind of motor by means of the magnet field generated by the stator windings under the control of computer programs; hence the realtime position information must be first acquired relying on the rotor position sensors. There are technical advantages through all the history for this kind of motor in being free of commutator abrasion, with high efficiency, and with simple structure. However, there are still drawbacks in itself:

(1) The noise and torque fluctuation of the motor are large;

(2) The development costs of electrical controllers are high; and

(3) The complexity of the rotor position sensors causes malfunctions easily.

Chinese patent 1 applied on Mar. 8, 2002 (patent application No. 02114949.6) proposed a coreless motor that is commutated with single brushes. However, that application does not propose any commutator structure that matches the single brushes.

Chinese patent 3 applied on Aug. 3, 2007 (patent application No. 200710143834.8) proposed an application for single-brush commutators in reluctance motors and DC permanent-magnet rotor motors. However, this application is different from traditional switched reluctance motors, in which winding currents are controlled by adjustable conducting angles and cut-off angles.

### SUMMARY OF THE INVENTION

This invention proposes a DC doubly salient reluctance motor commutated with traditional brushes and commutator technologies. This kind of motor is composed of a motor prototype of current switched reluctance motors, a traditional commutator component and a brush component, but there is not any rotor position sensor in the motor prototype. This kind of motor is composed of a motor stator component, a rotor component, a commutator component, a brush component and a shell, wherein windings being distributed on the stator core magnetic poles with salient poles, rotors being manufactured superposed from silicon steel segments with salient poles, two bearings being embedded in a bearing chamber located at a front and a back end cover, respectively, and a shaft crossing through the two bearings. The commutator component does not rotate with the shaft but the brush component rotates with the shaft. The number of commutator segments connected with windings on the commutator component is the least common multiple of the number of stator and rotor salient poles. The speed-adjusting, braking and reversal of the motor are achieved by means of shifting the circumferential positions of the commutator. The output power and the efficiency of the motor could be adjusted by means of adjusting the included angles between the front and the back edges of the brushes, and the automatic adjusting mechanics could be arranged in the motor, achieving realtime working condition adjusting according to application requirements.

There are special technical advantages for this kind of motor. As per permanent-magnetic DC brush motors:

(1) Electrical discharges between the commutator and brushes are greatly eliminated by flow-wheeling diodes, while reactive power energy of windings is regenerated, achieving higher motor efficiency, reducing abrasion of the commutator and brushes, thus acquiring a longer lifetime;

(2) The number of brushes in the maximum could be the same as the number of rotor salient poles; therefore being beneficial to reduce the dimension of the commutator or to reduce the current density of brushes;

(3) The commutator is positioned outside the motor prototype, which makes it unnecessary to dissemble the motor prototype if the commutator needs any maintenance, being free of carbon powder pollution to windings;

(4) The fixed commutator could reduce its requirement on structural strength, and the easy and firm brush component is suitable for rotation with higher speed; and

(5) The structure and the manufacture process are simple, and the costs are lower.

As per switched reluctance motors, this kind of motor:

(1) Inevitable noise and torque pulsation of switched reluctance motors are greatly eliminated by the unique way of servo drive of the commutator and brushes;

(2) The motor commutator and brushes may substitute rotor position sensors and expensive electrical controllers, which greatly reduces the overall costs of the motor system at the present level;

(3) The on and off time could be changed by rotating the commutator, corresponding to adjusting the conducting angle θ on or the cut-off angle θ off on the switched reluctance motor, achieving speed-adjusting, reversal and braking operations;

(4) The included angle or distance between the front and the back edges of the brushes could be adjusted by replacing brushes and brushes handles, corresponding to adjusting phase conducting angle θ on −θ off of phase windings on the switched reluctance motors; and

(5) θ on −θ off could be adjusted dynamically and real time by adjusting the positions of the fixed brushes and moving brushes.

To sum up, the controlling method of switched reluctance motors are completely employed in this kind of motor, almost completely substituting any switched reluctance motor that is still quite expensive without considering abrasion of brushes. In addition, the advantages of this kind of motor not only lie in its ease in adjusting common DC brush motors, but also in the way of speed-adjusting by rotating the commutator and adjusting the included angles between the front and the back edges of the brushes. Therefore, not only the advantages of switched reluctance motors and common DC brush motors are integrated in this kind of motor, but also the drawbacks of the two are avoided, being advantageous in higher rotation speed, lower costs and more control varieties, and greatly reducing the failure rates and the costs of dealing with the failures.

Although it is not hard to imagine the position interchanges of the rotating commutator with the fixed brushes as to form a scheme with fixed commutator and rotating brushes, this scheme proposes a specific implementation plan, thus producing great technical goodness and actual application value. Brand-new capabilities and controlling characteristics of this kind of motor are enabled by the invention, proposing a kind of technical approach for super large volume DC motors technologies.

### BRIEF DESCRIPTION OF THE DRAWINGS

FIG. 1a is a schematic view showing a 6-4 pole DC commutator doubly salient reluctance motor prototype employed in an embodiment of the invention.

FIG. 1a′ is a left-sided view showing the DC commutator doubly salient reluctance motor prototype shown in FIG. 1a.

FIG. 1b is a structural schematic view showing a commutator of the 6-4 pole DC commutator doubly salient reluctance motor.

FIG. 1c is a structural schematic view showing another commutator of the 6-4 pole DC commutator doubly salient reluctance motor.

FIG. 2 is a schematic view showing a commutator and a brush component in the first preferred embodiment of the invention;

FIG. 3a is a schematic view showing a linear controlled scheme of the commutator component and the brush component in the second preferred embodiment of the invention.

FIG. 3b is a schematic view showing position relationship of the commutator and brush when the linear controlled displacement commutator of the embodiment is at the initial position.

FIG. 3c is a schematic view showing position relationship of the commutator and brush after the displacement of the commutator in the embodiment.

FIG. 3d is a schematic view showing the relationship between positive and reverse speeds and the commutator position when the motor is under no-load condition.

FIG. 4a is a schematic view of the third preferred embodiment of the invention, i.e., the electric-controlled commutator component and the brush component.

FIG. 4b is a schematic view of the third preferred embodiment of the invention, i.e., the hand-adjusted displacement commutator component and the brush component.

FIG. 5 is a schematic view of the fourth preferred embodiment of the invention, i.e., the brush component with brush corners on the front and the back edges of a regulable brush.

FIG. 6 is a schematic view of the fifth preferred embodiment of the invention, i.e., a brush component with the included angle that could be realtime adjusted between the front and the back edges of the brush.

FIG. 7 is a schematic view of the sixth preferred embodiment of the invention, i.e., another kind of brush component with the included angle that could be realtime adjusted between the front and the back edges of the brush.

FIG. 8a is a schematic view showing the principle of adjusting the included angles between the front and the back edges of the brush in the seventh preferred embodiment of the invention.

FIG. 8b is a schematic view showing an example of the brush component in the seventh preferred embodiment of the invention.

In the drawings, 1. motor stator component; 10. motor prototype; 11. stator core; 12. stator windings; 12A. stator phase windings A; 12B. stator phase windings B; 12C. stator phase windings C; 2. motor rotor component; 21. rotor core; 22. shaft; 221. extension part of the shaft end; 23. bearing; 3. commutator; 31. commutator segments; 31A. commutator segments of the windings A; 31B. commutator segments of the windings B; 31C. commutator segments of the windings C; 32. source commutator segments; 33. cathode collector ring; 4. brush; 41. brush compression spring; 42. pulley; 421. pulley pull-spring; 422. pulley steel cable; 423. handle; 43. turbine; 431. worm; 432. worm-driven motor; 44. brush handle; 441. fixed brush handle; 442. fixed brush; 443. moving brush handle; 444. moving brush; 445. brush handle compression spring; 446. brush handle adjusting bolt; 45. brush handle cover; 451. fixed brush handle cover; 452. moving brush handle cover; 453. brush handle cover fixing bolt; 454. limiter convex; 455. brush handle reposition spring; 46. limiter block; 460. adjusting fork; 461. helical protruding teeth; 462. helical concave grooves; 463. plate groove; 47. axial adjusting block; 48. connecting rod; 481. connecting rod base; 482. linkage base; 49. limiter block steel cable base; 491. brush handle steel cable base; 492. steel cable guided base; 493. steel cable; 5. motor shell; 51. front end cover of the motor; 52. back end cover of the motor; 53. end cover of the commutator chamber; and 54. fastening bolt.

### DETAILED DESCRIPTION OF THE DRAWINGS

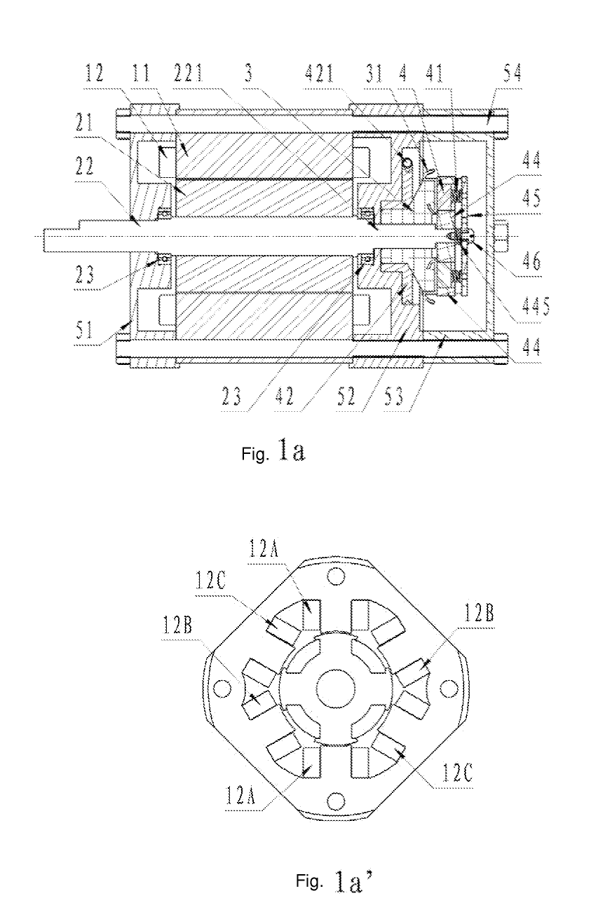

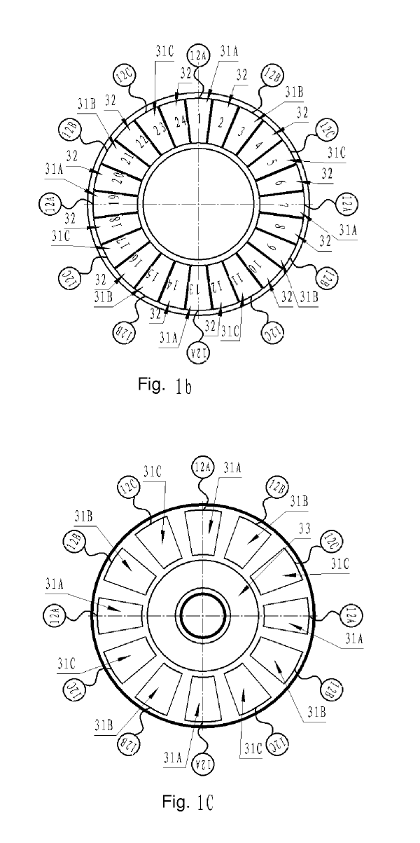

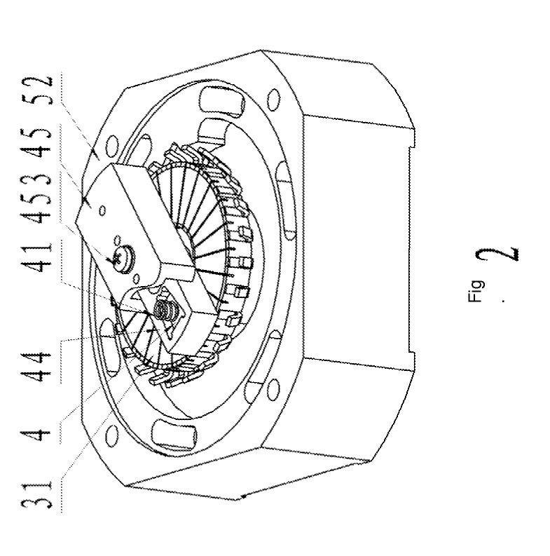

The first preferred embodiment of the DC commutator doubly salient reluctance motor technology is illustrated in FIG. 1a, FIG. 1a′ and FIG. 1b. The embodiment is based on 6-4 pole DC doubly salient motor, which sets the example for all illustrations of later embodiments. However, it does not mean that technologies in the following embodiments are limited to the 6-4 pole doubly salient motor only.

The motor prototype 10 is composed of a motor stator component 1, a rotor component 2, a commutator 3, a brush 4, and a motor shell 5. Three-phase windings 12A, 12B and 12C are mounted on the stator component 1, which is distributed on the stator core 11, two bearings 23 being embedded in the bearing chambers of the front end cover 51 and back end cover 52, respectively; a shaft 22 crossing the two bearings 23, aligning the rotor core 21 and the stator core 11 on the axial direction; the end of the extension part of the shaft end 221 extending to one side of its commutator segment 31 by crossing the central hole of the planar-type commutator 3, and the commutator 3 and the brush 4 being located in the commutator chamber between the back end cover 52 and the commutator end cover 53. Four fastening bolts 54 are connected together with the stator component 1 and the motor shell 5, locating each of its internal parts for a good working condition.

Such a commutator is employed in the invention, characterized in that the number of the commutator segments 31 connecting the windings on the commutator being the least common multiple of the number of the stator salient poles and the rotor salient poles, a commutator segment directly connecting one electrode of the source being arranged among the commutator segments 31 which connect the windings. Generally, this commutator segment is the cathode commutator segment 32 that connects with the cathode of the source.

In this embodiment, the said least common multiple is 12. There are 12 commutator segments 31 that connect with the windings on the commutator 3 of the embodiment, and a commutator segment 32 which connects with the source is arranged between each two windings commutator segments 31. Therefore, the overall number of the commutators 3 in this embodiment is 24, and the source polarity with which the commutator segment 32 connects is the source cathode.

One end of the commutator 31 is connected with the anodes of the flow-wheeling diodes through the windings, and the other end of the windings is connected with the source anode. The 24 commutator segments are wired according to the rules below:

| Index | Commutator Segments' Names | Connection |
|---|---|---|
| 1 | Commutator Segment 31A of the Windings A | Windings A |
| 2 | Commutator Segment 32 of the source | Source cathode |
| 3 | Commutator Segment 31B of the Windings B | Windings B |
| 4 | Commutator Segment 32 of the source | Source cathode |
| 5 | Commutator Segment 31C of the Windings C | Windings C |
| 6 | Commutator Segment 32 of the source | Source cathode |
| | . . . | |
| 23 | Commutator Segment 31C of the Windings C | Windings C |
| 24 | Commutator Segment 32 of the source | Source cathode |

If the commutator segments indices A, B, and C on the commutator are arranged according to a counter-clockwise sequence, the windings indices A, B and C on the stator must be arranged according to a clockwise direction. Thus such a technical feature of the motor of the invention could be inferred: the distributing sequence of different windings on the stator salient poles is contrary to their connecting sequence with the commutator segments on the commutator.

The form and wiring sequence of this 24-planar commutator kind are shown in FIG. 1b. Another form of the planar commutator is shown in FIG. 1c, where the commutator is provided with commutator segments 31 that are connected with the windings, and instead of commutator segments 32 that are directly connected with the source cathode, a cathode collector ring 33 is employed. A cathode collector ring brush is matched with the cathode collector ring 33.

A structure example of the commutator and brush component assembled in FIG. 1 is shown in FIG. 2. A brush handle 44 is limited on the shaft, thus leaving with only axial freedom, the brush handle cover 45 being mounted on the axial outside of the brush handle 44 and fastened at the end of the extension part of the shaft end 221 by a brush handle cover fixing bolt 453. A supporting surface for a brush compression spring 41 and a brush handle compression spring 47 in the brush handle 44 is provided by the brush handle cover 45. The brush handle 44 is slightly pressed by the brush handle compression spring 47 to make it adhered onto the surface of the commutator 3, avoiding brush deflection under contact friction resistance and providing support for the correct work of the brush. The complete covering of the brush handle 44 on the surface of the commutator 3 is beneficial for dustproof of the commutator 3 and avoidance of worsening contact conditions between brush 4 and commutator 3.

The technical features of the invention also include: all brushes connecting with only one polarity of the same source, and the number of the brushes being no longer a couple of a normal DC motor but can be at most equal to the number of rotor salient poles. Since there are four salient poles on the rotor in the first embodiment, at most four brushes are allowed to be mounted in the embodiment. Four same brushes 4 could be distributed uniformly at 90° intervals on the brush handle 44, which would greatly reduce the size of the commutator or reduce the brush current density, lowering the brush temperature, and decreasing the malfunctions of the commutator and the brushes.

Two brush positions distributed at 180° intervals are arranged in the first preferred embodiment of the invention, and two same brushes are used to contact the commutator. The purpose of doing this is to reduce the friction resistance generated by brushes and to enhance heat dissipation of the commutator. But, anyway, the brush and brush handle distribute symmetrically for the mass balance.

The first preferred embodiment is a simple form of the technical scheme of the invention. The commutator in this form is fixed and the included angles φ between the front and the back edges of the brush are fixed values. Circumferential positions of the commutator can be determined and brushes with suitable included angles φ between the front edges and back edges can be chosen to be arranged onto the motor before its manufacturing, so that the motor output can meet expected requirements in a prearranged way. However, no matter how the included angles φ between the front and the back edges of the commutator are set or are varied, the following case should never occur:

The brush might be located in an area between two winding commutators 31 and does not contact with any winding commutator 31.

In order to prevent such a phenomenon from happening, the included angles φ between the front and the back edges of the brush should satisfy this following relationship:

φ=(the included angles between stator salient poles+the included angles between rotor salient poles)×0.5−the included angles between the front and the back edges of the winding commutator 31

This relationship applies to planar-type or cylindrical commutators in all technical schemes of the invention.

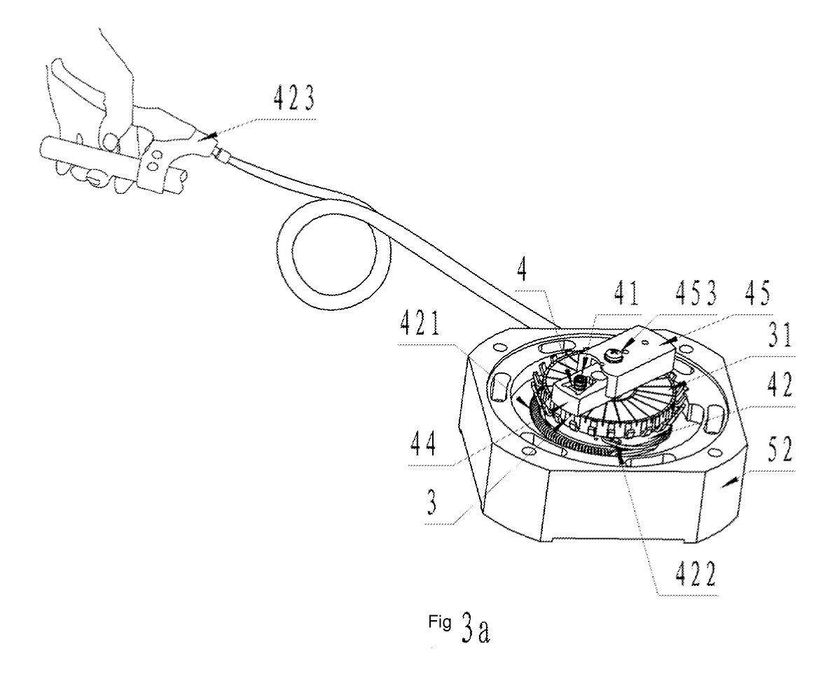

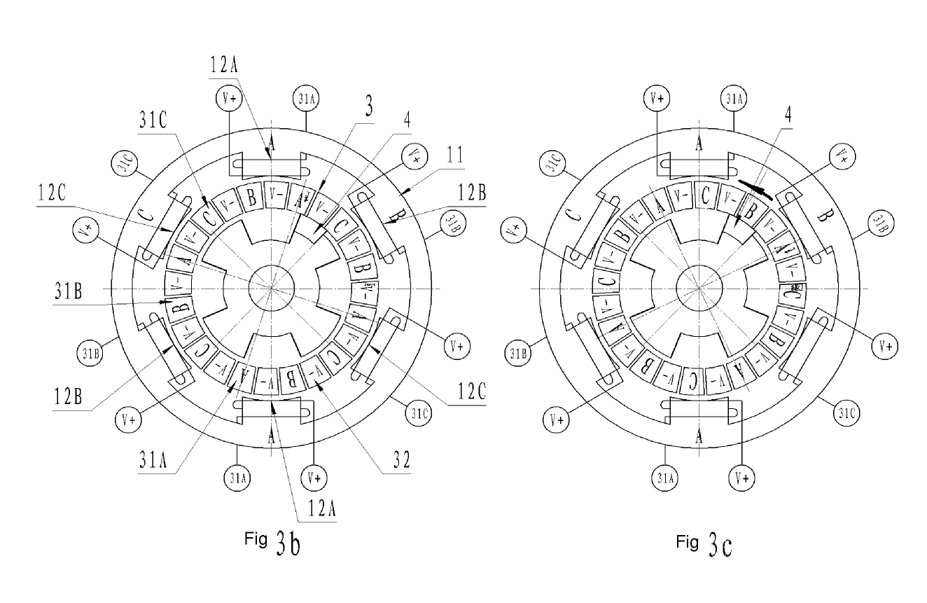

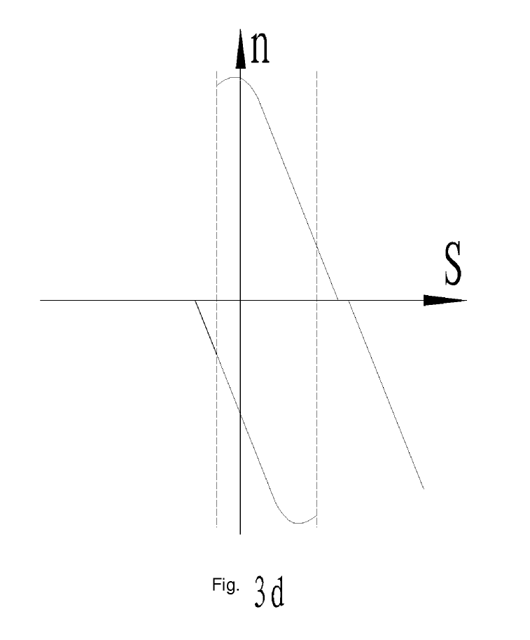

The second preferred embodiment of the invention is shown in FIG. 3, the embodiment being a linearly controlled speed-adjusting, braking and reversal scheme. In FIG. 3a, a steel cable pulley 42 and a pulley steel cable 422 are fixed on a commutator 3 in this scheme so as to adjust the circumferential positions of the commutator 3 by a handle 423 and to shift its position relative to stator salient poles. Furthermore, a pulley pull-spring 421 is arranged on the commutator so that the pulley pull-spring 421 could pull the commutator 3 back to its initial position when the pulling force on the pulley steel cable 422 decreases.

A way of linear control is employed in this embodiment of the invention, enabling speed-adjusting, braking, and reversal rotation by using a rotating commutator to change its position relative to stator salient poles, characterized in that: rotating the commutator relative to the stator salient poles surround a shaft in order to shift its circumferential positions.

A steel cable at an initial position is shown in FIG. 3b. It is assumed that the fastest rotation speed point is achieved by the motor at this position. When the handle is grasped completely by an operating staff, the relocation operation is completed by the commutator 3, the commutator 3 rotating counter-clockwise to the position in FIG. 3c. The motor is in an efficient braking state at this moment. The rotation speed decreases gradually as the handle stroke increases between the two positions, and the motor comes into a stepless speed-adjusting condition.

If the commutator is rotated reversely by a braking process at the initial position, a reversal would be completed quickly by the motor after a slight reduction of the rotation speed. The rotation speed after reversal would be lower than the rotation speed before the reversal.

A schematic view showing the relationship between the reversible rotation speed n and the commutator position S when the motor runs without any load is shown in FIG. 3d. If the stator salient poles corresponding to certain electrical windings are at the middlemost position between two neighboring rotor salient poles after the occurrence of the circumferential positions of the commutator shift, it is the time for the motor rotation speed to change. If the rotor salient poles at the current rotation direction side of the stator salient poles are called forward rotor salient poles, and the rotor salient poles in the direction that is contrary to the rotation direction of the stator salient poles are called backward rotor salient poles, the stator salient poles with electrical windings would maintain greater attractive force to backward rotor salient poles if the motor maintains the rotation direction unchanged. Therefore, if the commutator continues to be rotated when the commutator position draws near to the position that the rotation speed changes, the stator salient poles with electrical windings would generate more attractive force to the forward rotor salient poles than to the backward rotor salient poles, and an abrupt change of the rotation direction would occur at that moment.

The rotation speed value n is small and may be associated with motor vibration after the abrupt change of the rotation direction. If the commutator is reversely rotated at this moment, the rotation speed would be increased gradually in the rotation speed direction after the direction change, achieving the maximum gradually with the increase of the commutator relocation. Then the rotation speed direction change would occur again. If the commutator relocation continues in the original direction after the rotation speed direction change, the rotation speed of the motor would continue being decreased, and the vibration range would be increased. The motor would come into a stasis condition henceforth, then the motor rotation speed would start to rotate reversely and the rotation speed in the reverse direction would be increased gradually.

Vibration and noise of the general switched reluctance motors would occur to the motor only when the motor rotates at a low speed. It is caused by the influence of the freewheeling of the windings to the rotation, i.e., the result of too long freewheeling time caused by the relatively long conducting time and excessive windings current, when the rotation speed being low.

As to 8-6 poles DC commutator doubly salient reluctance motors, the effect of stepless speed-adjusting, braking and reversal can also be generated by shifting the circumferential positions of the commutator.

The rotation speed of the motor must be reduced to zero by the rotation speed direction change of the switched reluctance motor, and then the parameters are exchanged to transfer the controlled object from current rotor salient poles to neighboring rotor salient poles, starting again the start-up progress of the motor. Moreover, the motor direction change of the commutator doubly salient reluctance motor may be finished quickly. The more load of the motor is, the lower the rotation speed at which the direction change occurs, and the higher the rotation speed becomes after the direction change.

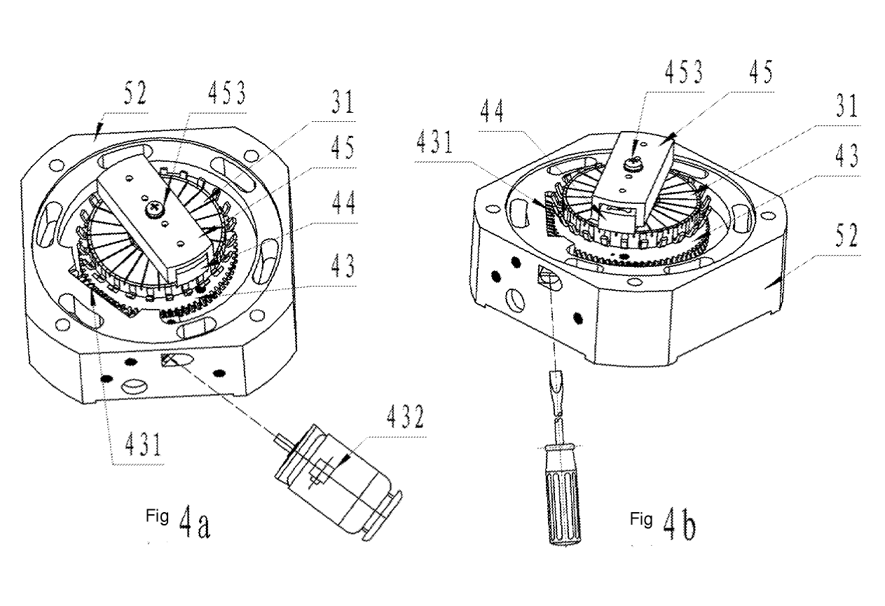

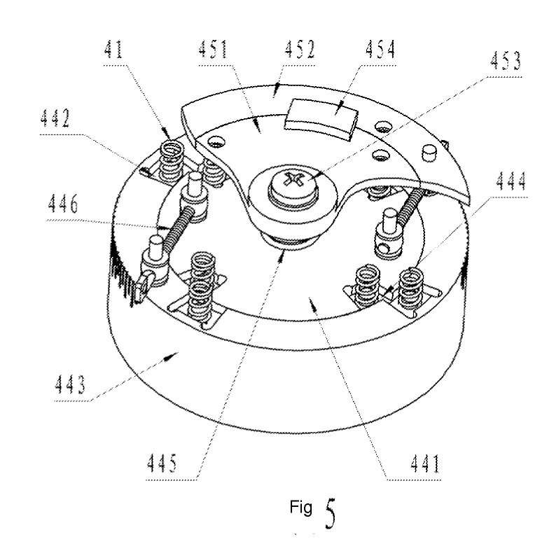

The third preferred embodiment of the invention is shown in FIG. 4. An electric-driven scheme of electrical worm is employed in the technologies that adjust the commutator positions in the scheme.

In FIG. 4a, a worm 431 is driven to rotate with turbine 43 by a worm-driven motor 432, the turbine 43 still remaining fixed with the commutator 3. Stepless speed-adjusting, braking and reversal operations of the motor could achieved when the commutator 3 is driven to rotate in two directions by the worm-driven motor 432 through positive and negative rotations.

A position servo motor might be employed by the worm-driven motor 432 in order to achieve the computer program—controlled effect that is similar to switched reluctance motors.

Also a manual adjusting by means of screwdrivers could be employed by the worm 431 in FIG. 4a, as shown in FIG. 4b. The manufacturing setting program shown in the structure in FIG. 2 could be conveniently substituted in this way and the circumferential positions of the commutator 3 could be arranged according to requirements at worksite at any time.

The first, second and third preferred embodiments of the invention are technical special cases to adjust the motor output features by adjusting ton under the condition where conducting angles are fixed. How to adjust conducting angles in realtime would be described in this embodiment and the following embodiments.

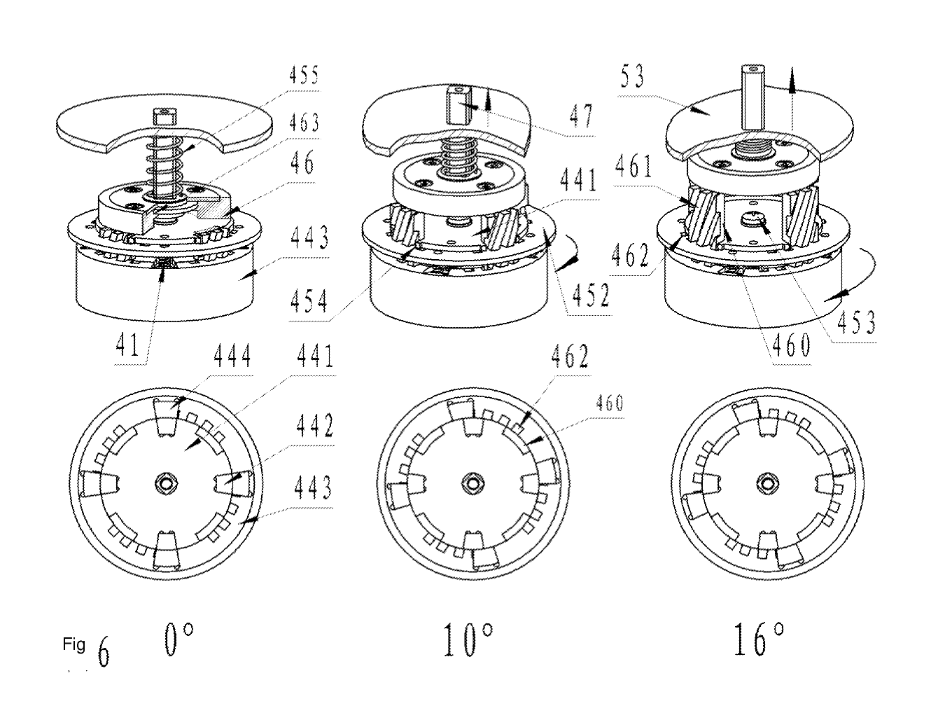

The fourth preferred embodiment of the invention is shown in FIG. 5. In addition to the technical scheme that uses circumferential reposition of the commutator 3, the brush handle technology that can adjust the included angles between the front and the back edges of the brushes is also used in this embodiment.

In FIG. 5, the brush 4 is composed of a fixed brush 442 and a moving brush 444, and a fixed brush handle 441 and a moving brush handle 443 that match with them, the brushes 442, 444 and the brushes handles 441, 443 rotating with the shaft, the fixed brush 442 and the moving brush 444 both having their own brush compression spring 41, the fixed brush handle cover 451 being fastened at the shaft end by the brush handle cover fixing bolt 453, the limiter convex 454 pushing down the moving brush handle cover 452 so that it keeps the axial position with the fixed brush handle cover to avoid being driven by brush compression spring 41. It is characterized in that: the moving brush handle 443 occurring circumferential displacement relative to the fixed brush handle 441, which makes a mismatch occurs on the front edge of the moving brush handle 444 at the superposed position relative to the front edge of the fixed brush 442, an angle stroke occurring between the front edge of the moving brush 444 and the back edge of the fixed brush 442, which would eventually cause the conducting time of all windings that are connected to the commutator changes at the same extent.

There is a brush handle adjusting bolt 446 between the moving brush handle 443 and the fixed brush handle 441 in this embodiment, enabling the moving brush handle 443 move circumferentially surrounding the shaft relative to the fixed brush handle 441 by adjusting the bolt 446, driving the moving brush 444 and the fixed brush 442 that are initially superposed at the front and the back edges, respectively, to move circumferentially, increasing the actual conducting time of the brush 4 composed of the fixed brush 442 and the moving brush 444 relative to every commutator segment 31. It means that the included angles between the front and the back edges of the brush are actually increased, i.e., increasing the driving current and enhancing the output power when the motor rotates.

While the position of the moving brush front edge is being adjusted, the back edge of the fixed brush can also be moved forward by means of adjusting the position of the commutator in order to ensure the electricity to be cut off before the inductance of the phase windings decreases, ensuring the freewheeling not be extended into the inductance decreasing zone.

In this embodiment, the fifth preferred embodiment of the invention is shown in FIG. 6. Different from the embodiment shown in FIG. 5, the included angles between the front and the back edges of the brush can be adjusted in realtime during the rotation period of the motor in this embodiment.

Not only the fixed brush 442 and the moving brush 444, the fixed brush handle 441 and the moving brush handle 443, but also the axial adjusting block 47 and the limiter block 46 are included in the brush component in this embodiment.

The technical features of the embodiment are that: the limiter block 46 not only rotating synchronously with the fixed brush handle 441 and the shaft 22 under the curb of the fixed brush handle 441 or the shaft 22, but also moving axially under the curb of the axial limiter block 47. When being axially still, the moving brush handle 443 and the fixed brush handle 441 are curbed to rotate synchronously by the limiter block 46. When it reciprocates axially, the limiter block 46 is driven reciprocates axially by the axial limiter block 47, causing the moving brush handle 443 to reciprocate circumferentially relative to the fixed brush handle 441 during rotation and the moving brush 444 in the moving brush handle 443 to reciprocate circumferentially with the fixed brush 442 in the fixed brush handle 441.

The technical implementation scheme of the embodiment is: the fixed brush 442, the fixed brush handle 441, the moving brush 444 and the moving brush handle 443 are similar to those in FIG. 5. The fixed brush handle 441 is inside the ring part of the ring-shaped moving brush handle 443. There is a belt-shaped space with four adjusting forks 460 on the limiter block 46 at one side of the fixed brush handle 441 on the radial interface part thereof.

Four adjusting forks 460 are arranged on the limiter block 46 in the direction facing the commutator 3, the adjusting forks 460 crossing through the fixed brush handle 451 and the moving brush handle 452, extending to the fixed brush handle 441 and the moving brush handle 443. There are axial straight convex teeth on the inner edge of the adjusting forks of the limiter block 46, and there are axial straight concave teeth that match with the same on the fixed brush handle 441. It is thus determined that the limiter block 46 be rotated synchronously with the fixed brush handle 441.

There are helical protruding teeth 461 on the outer edge of the adjusting forks of the limiter block 46, and there are helical concave grooves 462 that match with the same on the inner edge of the moving brush handle 443. The pitch of the helical grooves 462 is large so that the moving brush handle 443 with helical concave grooves 462 may be driven to reciprocate circumferentially surrounding the shaft by the helical protruding teeth 461 when the limiter block 46 moves up and down.

Therefore, the technical features of this embodiment also include: achieving the synchronization and mismatch movement control of the moving brush handle 443 and the fixed brush handle 441 by the means of axial straight teeth grooves 460 and helical protruding teeth 461.

The structures of the fixed brush handle cover 451 and the moving brush handle cover 452 are the same as those of the two brushes handles. The helical concave grooves of the two brushes handles 441, 443 match with the two brush-handle covers 451, 452, synchronizing the movement of the moving brush handle 443 and the moving brush handle cover 452 when the limiter block 46 moves straightly. Moreover, there is a limiter convex 454 that refrains the moving brush handle cover 452 from moving axially away from the commutator 3 on the outer edge of the fixed brush handle cover 451.

There is a plate groove 463 on the end far from the commutator 3 of the limiter block 46. The plate groove 463 is embedded into the round plate on the axial adjusting block 47. The structure of the plate groove and the round plate is actually one two-way static thrust sliding bearing. Moreover, the section of the end extension part of the axial adjusting block 47 is not a round shape, and the end extension part extends from the central hole of the end cover of the commutator chamber 53. The shape of the hole is the same as that of the section of the end extension part of the axial adjusting block 47. Therefore, the axial movement of the axial adjusting block 47 could be transferred to the limiter block 46, and the rotation of the limiter block 46 surrounding the shaft could not be transferred to the axial adjusting block 47.

When the axial adjusting block 47 reciprocates axially, it drives the limiter block 46 that rotates synchronously with the shaft to reciprocate axially. Due to the functions of the straight groove at the inner edge of the adjusting forks and the helical protruding teeth of the outer border, the moving brush handle 443 and the fixed brush handle 441 reciprocate circumferentially while they rotate with the shaft, driving the front edge of the moving brush 444, creating reciprocation which moves forward from the superposed position of the front edge of the fixed brush 442 and back to the initial position, which makes the value of the conducting angle vary with increase and renewal to the initial value, thus adjusting the driving current of the motor with increase and renewal to the initial value.

In this embodiment, both the way to use fixed brush handle 441 which is located inside the ring part of the ring-shaped moving brush handle 443 and the way to use moving brush handle 443 which is located inside the ring part of the ring-shaped fixed brush handle 441 are valid. Also, other technical implementation schemes are possible under the same technical feature.

The features in the preferred embodiment indicates that if the helical protruding teeth on the inner edge whose rotation directions are the same as those of the helical protruding teeth 461 on the outer edge are employed instead of the inwardly convex straight protruding teeth by the adjusting forks 460, the fixed brush handle 441 would be moved circumferentially driven by the helical protruding teeth on the inner edge of the adjusting forks, thus achieving the same effect as that of the circumferential rotation of the commutator to realize the technical effect that the conducting angle and cut-off angle of the windings vary together according to a predetermined relationship.

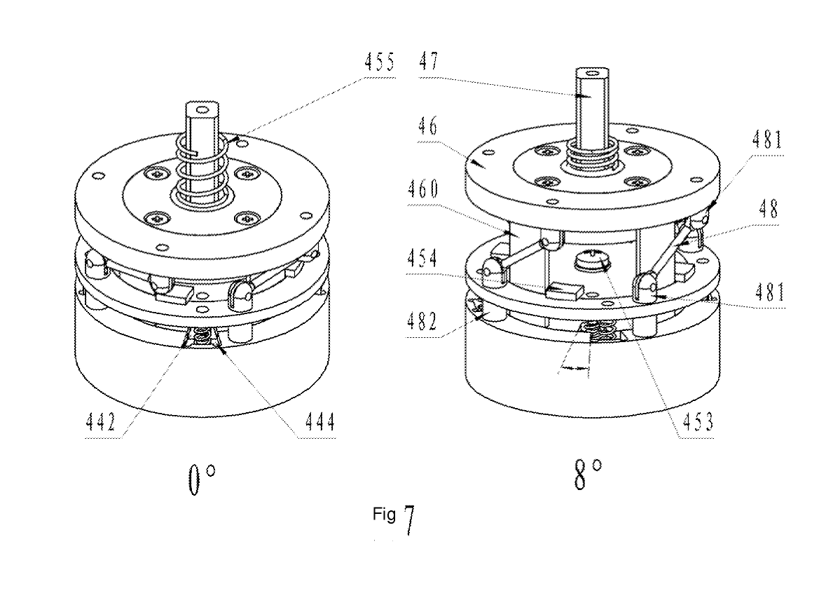

The sixth preferred embodiment of the invention in FIG. 7, which is also another technical scheme of the fifth preferred embodiment.

The fixed brush handle 441 in this scheme is still located inside the ring part of the moving brush handle 443. The limiter block 46 still synchronizes with the fixed brush handle 441 by four adjusting forks 460, the moving brush handle cover 452 being curbed by the four adjusting forks 460 through four connecting rods 48 and the connecting rod base 481, synchronizing the moving brush handle 443 with the moving brush handle cover 452 by four linkage bases 482.

The limiter convex 454 is still on the fixed brush handle cover 451 so as to refrain the moving brush handle 443 from moving axially away from the commutator 3.

When the axial adjusting block 47 moves away from the rotor core, the connecting rod 48 would be uplifted and the moving brush handle cover 452 would be pulled by the limiter block 46. The moving brush handle 443 would also be pulled to move circumferentially through the linkage base 482 to cause mismatch between the fixed brush 442 and the moving brush 444 on the edge, achieving the effect of changing the effective included angles between the front and the back edges of the brush.

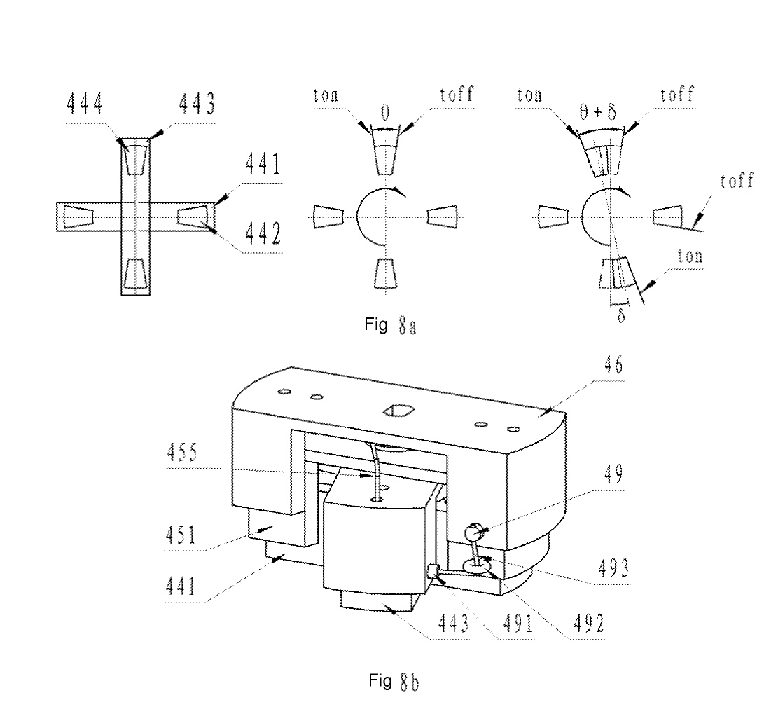

The seventh preferred embodiment of the invention is shown in FIG. 8, which is also another technical scheme for 6-4 poles DC doubly salient motor that adjusts the included angle of the front and the back edges of the brush.

Because the number of commutator segments that are connected with one winding in this embodiment is four, and the number of brushes is also four, the conductance of one winding corresponds to the conductance of four commutator segments at the same time, and the conducting angle θ=|tₒₙ−t_{off}| is determined by the included angles between the front and the back edges of the brushes.

As shown in FIG. 8a, the conducting time θ, tₒₙ and t_{off} of the four brushes are the same when the four brushes are distributed on the circle at 90° intervals. If the moving brush handle 443 has an angle displacement of δ counter-clockwise, the commutator segments would be conducted δ ahead of schedule relative to the fixed brush 442 and be cut off δ ahead of schedule by the moving brush 444 when the motor rotates clock-wise, the fixed brushes 442 still being conducted and cut off at scheduled time. The commutator segments 31 in this way would have an effect upon conducting δ ahead of schedule and cutting off at scheduled time relative to the brush 4 which is composed of the moving brush 444 and the fixed brush 442. Thus the purpose of increasing the included angles between the front and the back edges of the combined brushes without breaking the brushes up is achieved.

As shown in FIG. 8b, the implementation technical scheme in this embodiment is that: the brush component comprising two brushes handles 44 and two brush-handle covers 45, one limiter block 46 and steel cables 63. The two brushes handles 441, 443 and the brush-handle covers 451, 452 are assembled superposed on the shaft 22 like scissors arms, and a steel cable mechanics is arranged on the fixed brush handle 441 so as to curb the moving brush handle 443, which superposes with the fixed brush handle 441 like scissors arms, changing the scissors difference angle.

In initial conditions, the included angles between the midlines of the two brushes handles are 90°. The limiter block steel cable base 49 pulls the steel cable 493 when the limiter block 46 moves upward and pulls the brush handle steel cable base 491 on the opposite moving brush handle cover 443 through the steel cable guided base 492, causing the moving brush handle 443 to approach the fixed brush handle 441 in the form of a decreasing scissors angle for the purpose of increasing the actual front edge angles of the two groups of brushes. The brush handle reposition spring 455 causes the moving brush handle 443 to approach the initial position in the form of an increasing scissors angle when the limiter block 46 moves downward, decreasing the actual front edge angles of the two groups of brushes to approximately the initial value.

The preferred commutators in the invention are planar commutators. Since there are some disadvantages for the brush in the cylindrical commutators under rotational conditions, the applications of cylindrical commutators are not considered as preferred embodiments in this invention. However, the applications of the cylindrical commutators for this invention are not excluded in this invention.

The preferred commutators in the invention are planar commutators; however, the applications of the cylindrical commutators for this invention are not excluded in this invention. The reasons for not employing the cylindrical commutators as preferred embodiments in this invention are due to the following disadvantages:

(1) The pressure caused by the rotated brush towards the commutator surface due to the centrifugal force changes with the rotation speed;

(2) The lengths of external brushes are limited due to the influence of the centrifugal force, and the lengths of internal brushes are also limited by the radii of the internal contact interfaces of the commutators even if the commutators are internal ones;

(3) The brushes could not maintain contact on the fully arched surface easily with the cylindrical surface of the commutators; and

(4) The decrease of the outer diameters of the commutators caused by the surface abrasion of the cylindrical commutators would make changes to the conducting relationship between the brushes and the commutator segments.

The motors in the invention are 6-4 poles doubly salient reluctance motors; however, the distribution rules of the commutator segments and the value rules of the commutator segments proposed in the said technical schemes of the invention are applicable for doubly salient reluctance motors with other pair numbers of the stator and rotor poles including 8-6 poles, in which the only difference is the number of commutator segments 31 connected with the windings on the commutators.

Also, the direct driving windings form is employed in the said commutator and brushes of the invention. It certainly falls in the said technical scope of the invention if the said commutator and the brushes components in the invention are connected with the driving ends of electrical power controllers and the windings are driven by the output ends of the electrical power controllers.

1. A DC commutator doubly salient reluctance motor, the motor comprising:
a motor stator component, a rotor component, a commutator component, a brush component and a motor shell,
wherein windings are distributed on stator core magnet poles with salient poles, the rotor being superposed made of silicon steel segments with salient poles, a shaft crossing through two bearings, commutator segments being connected with stator windings; and
wherein said commutator component does not rotate with the shaft, while the brush component rotates with the shaft.

2. The DC commutator doubly salient reluctance motor of claim 1, possessing the ability of speed-adjusting, braking and reversal operations, wherein relative positions of the commutator and the stator salient poles are adjustable at any time.

3. The DC commutator doubly salient reluctance motor of claim 2, wherein a number of brushes is at most equal to a number of rotor salient poles.

4. The DC commutator doubly salient reluctance motor of claim 3, wherein commutator segments are arranged directly connected with one polarity of a source between the commutator segments that connect with the windings.

5. The DC commutator doubly salient reluctance motor of claim 4, wherein a planar-type commutator is employed by the commutator.

6. The DC commutator doubly salient reluctance motor of claim 5, wherein the commutator is located outside of the motor prototype.

7. The DC commutator doubly salient reluctance motor of claim 6, wherein the number of the commutator segments connected with the windings equals to the least common multiple of the number of the motor stator salient poles and the rotor salient poles.

8. The DC commutator doubly salient reluctance motor of claim 7, the wherein a distributing sequence of different windings on the stator salient poles is contrary to a corresponding connecting sequence with the commutator segments on the commutator.

9. The DC commutator doubly salient reluctance motor of claim 2, the motor conducting speed-adjusting, braking and reversal operations by changing the relative positions of the commutator and the stator salient poles by means of linear control or electrical control, wherein, when the linear control means is employed, a pulley and a steel cable are fixed on the commutator so as to adjust circumferential positions of the commutator by a handle, a pull-spring being arranged on the commutator so that the pull-spring would be pulled back to its initial position when the steel cable pull decreases, and wherein, when the electrical control means is employed, a turbine is curbed to rotate by a worm driven by a worm-driven motor, the turbine being fixed with the commutator, the worm driving the motor to curb the commutator for a two-way rotation by positive and reversal rotations.

10. The DC commutator doubly salient reluctance motor of claim 2, the brush component being comprised of a fixed brush and a moving brush, and a fixed brush handle and a moving brush handle that match with them, the brush and the brush handle rotating with the shaft, wherein the moving brush handle occurs circumferential displacement relative to the fixed brush handle, which makes a mismatch occurs on the front edge of the moving brush handle relative to the front edge of the fixed brush at the superposed position, and an angle stroke occurs between the front edge of the moving brush and the back edge of the fixed brush.

11. The DC commutator doubly salient reluctance motor of claim 10, the brush component further comprising an axial adjusting block and a limiter block, wherein the limiter block not only rotates synchronously with the fixed brush handle and the shaft under the curb of the fixed brush handle or the shaft, and wherein the limiter block also moves axially under the curb of the axial limiter block; the limiter block curbing the moving brush handle and the fixed brush handle to rotate synchronously when it becomes static axially, the axial limiter block driving the limiter block reciprocates axially when it reciprocates axially, causing the moving brush handle to reciprocate circumferentially relative to the fixed brush handle during rotation and the moving brush in the moving brush handle to reciprocate circumferentially with the fixed brush of the fixed brush handle.

12. The DC commutator doubly salient reluctance motor of claim 5, the motor conducting speed-adjusting, braking and reversal operations by changing the relative positions of the commutator and the stator salient poles by means of linear control or electrical control,
wherein, when the linear control means is employed, a pulley and a steel cable are fixed on the commutator so as to adjust circumferential positions of the commutator by a handle, a pull-spring being arranged on the commutator so that the pull-spring would be pulled back to its initial position when the steel cable pull decreases, and
wherein, when the electrical control means is employed, a turbine is curbed to rotate by a worm driven by a worm-driven motor, the turbine being fixed with the commutator, the worm driving the motor to curb the commutator for a two-way rotation by positive and reversal rotations.

13. The DC commutator doubly salient reluctance motor of claim 8, the brush component being comprised of a fixed brush and a moving brush, and a fixed brush handle and a moving brush handle that match with them, the brush and the brush handle rotating with the shaft, wherein the moving brush handle occurs circumferential displacement relative to the fixed brush handle, which makes a mismatch occurs on the front edge of the moving brush handle relative to the front edge of the fixed brush at the superposed position, and an angle stroke occurs between the front edge of the moving brush and the back edge of the fixed brush.
